(19) United States
(12) Patent Application Publication
(10) Pub. No.: US 2014/0023468 A1
(43) Pub. Date: Jan. 23, 2014

(54) VEHICLE-MOUNTED ARTICULATED ARM FOR DISCHARGING BINS

(71) Applicants: Jean Fortin, Drummondville (CA); Gérard Bpiffard, Laval (CA); Clermont Fortin, Notre-Dame-du-Bon-Conseil (CA)

(72) Inventors: Jean Fortin, Drummondville (CA); Gérard Bpiffard, Laval (CA); Clermont Fortin, Notre-Dame-du-Bon-Conseil (CA)

(73) Assignee: VEHICULES INPAK INC./INPAK VEHICLES INC., Drummondville, QC (CA)

(21) Appl. No.: 13/147,877

(22) PCT Filed: May 30, 2011
(86) PCT No.: PCT/CA11/00643

§ 371 Date: Oct. 4, 2013

Related U.S. Application Data
(60) Provisional application No. 61/471,333, filed on Apr. 4, 2011.

(51) Int. Cl. B65F 1/14; B65F 3/04

(52) U.S. Cl. CPC B65F 1/1452; B65F 3/048
USPC 414/408; 414/403

(57) ABSTRACT

The present document describes a collection container or vehicle-mounted articulated arm for discharging bins in a collection container. The arm comprises an attachment section which allows for mounting the arm on a collection container or a chassis of a vehicle carrying a collection container without effecting any alterations to the existing mechanism/structure of the collection container and/or the truck on which the collection container is provided. The arm also comprises an articulation mechanism winch allows the arm to extend for grabbing the bin, lift the bin upward to discharge its content in the collection container, lower the bin to place it back on the ground, and retracts back toward the collection container for storage and/or transportation. An arm according to the present embodiments may be made from light materials such as aluminum without affecting its lifting capacity. In an embodiment, the weight of the bin applies a pressure on the arm, which pressure causes the arm to retract after grabbing the bin.

### BACKGROUND

(a) Field

The subject matter disclosed generally relates to an articulated arm for reaching, grabbing and discharging bins.

(b) Related Prior Art

In the conventional arms used for reaching, holding and discharging bins, a tradeoff exists between the weight and complexity of the arm on one hand and the capacity and durability of the arm on the other hand. That is, the arm has to be very heavy in order to last longer and hold heavy bins.

These arms are always made of steel/iron, and include too many adjustable pieces such as chains. The maintenance of these arms is quite difficult and time consuming because once the adjustable pieces are lubricated, the arms need to be re-calibrated before being used.

Moreover, conventional arms require substantive modifications in the existing structure of the collection container and/or the truck associated with it. These modifications often require cutting parts of the existing chassis in order to install the arm.

Therefore, there is a need for an arm which is effective, lightweight and easy to install and maintain.

### SUMMARY

According to an embodiment, there is provided an articulated arm for mounting on a collection container or a chassis of a vehicle carrying a collection container for discharging bins, comprising:
an attachment section for attaching to the collection container or the chassis of the vehicle;
an elongated first section having a first end and a second end, the first end of the first section being pivotally connected to the attachment section at a first pivot point;
an elongated second section having a first end and a second end, the first end of the second section being pivotally connected to the second end of the first section at a second pivot point; and
a grabbing section pivotally connected to the second end of the second section at a third pivot point, the grabbing section including a set of clamps which rotate between an open position for storage and transportation and a closed position for grabbing the bin.

The arm comprises an articulation mechanism which allows the arm to move between from folding position to an extended position for grabbing the bin, rotate around the second pivot point for lifting the bin toward an opening of the collection container, and tilt the grabbing section around the third pivot point for discharging the bin into the collection container.

The grabbing section may remain in a substantially parallel position to the ground as the arm is lifting the bin toward the opening of the collection container.

The grabbing section may remain in a substantially parallel position to the ground as the arm is folding and unfolding.

The grabbing section may maintain its elevation from ground when unfolding to grab the bin.

The weight of the bin may exert a pressure which assists in retracting the arm toward the folding position. The pressure may be proportional to the weight of the bin.

The articulated arm may further comprise a reach cylinder pivotally connected between the first section and the attachment section, the reach cylinder cause the arm to unfold when extending, and to fold when retracting. During folding and unfolding of the arm, the first section may rotate around the first pivot in a direction of rotation that is opposite to a direction of rotation of the second section around the second pivot point.

The articulated arm may further comprise at least one elevation cylinder pivotally attached to the attachment section at one end and to an elevation rod at another end, the elevation rod to exert an elevation-torque on the second section which causes the second section to rotate around the second pivot point, following an axial movement by the elevation cylinder. The rotation of the first section around the first pivot point causes the elevation cylinder to exert a torque on the elevation rod to rotate the second section around the second pivot point in a direction of rotation that is opposite to the direction of the first section around the first pivot point.

The second section may comprise a tilt cylinder operatively connected to the grabbing section for tilting the grabbing section around the third pivot point when the bin approaches the opening of the collection container.

The clamps may be connected to a grabbing cylinder for opening and closing.

The second section may be received within the first section when in a folding position.

The articulated arm may be made from a material lighter than steel.

The articulated arm may be made substantially entirely from aluminum.

The articulated arm may weight 850 pounds, may extend up to 16 feet and may grab a bin that weighs up to 2000 pounds.

The articulated arm for mounting on a collection container or a chassis of a vehicle carrying a collection container for discharging bins, comprising:
an attachment section for attaching to the collection container or the chassis of the vehicle;
an elongated first section having a first end and a second end, the first end of the first section being pivotally connected to the attachment section at a first pivot point;
an elongated second section having a first end and a second end, the first end of the second section being pivotally connected to the second end of the first section at a second pivot point;
a grabbing section pivotally connected to the second end of the second section at a third pivot point, the grabbing section including a set of clamps which rotate between an open position for storage and transportation and a closed position for holding the bin;
the arm comprises an articulation mechanism which allows the arm to move from a folding position to an extended position for grabbing and discharging the bin, wherein the weight of the bin exerts a pressure which assists in retracting the arm toward the folding position.

In the following embodiments the term pivot point may be interpreted to mean a rotation axis or rotation shaft.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a side view of an embodiment of a vehicle-mounted articulated arm, in a discharging position;

FIG. 1b is a side view of an attachment section shown separately;

FIG. 2 illustrates the articulated arm of FIG. 1 operatively connected to a collection container;

FIG. 3 illustrates a chassis of the second section;

FIG. 4 illustrates a reach cylinder connected between an attachment section and a chassis of the second section;

FIG. 5 illustrates the elevation cylinders and the rods of an elevation mechanism;

FIGS. 6 and 7 illustrate rods of an elevation mechanism;

FIG. 8 is a side view of the third section in an elevation position;

FIG. 9 illustrates the elements of the tilt control mechanism, in accordance with an embodiment;

FIGS. 10 to 12 illustrate the individual elements of the mechanism of FIG. 9;

FIG. 13a is an exploded view of a tilting mechanism used for tilting the bin for discharging its content in the collection container;

FIG. 13b is an inside view of a tilting mechanism shown in FIG. 13a;

FIGS. 14a is a front view of the fourth section without the front protecting cover,

FIG. 14b is a top view of the fourth section without the top protecting cover;

FIGS. 15a to 15e illustrate an articulated arm in different stages of operation;

FIG. 16 illustrates the pivot point configuration which allows the clamps to remain in a horizontal position;

FIG. 17a illustrates the concept of applying the weight of the bin for retracting the arm though the chassis of the second section, and

FIG. 17b illustrates the concept of applying the weight of the bin for retracting the arm though the arm housed within the chassis of the second section.

It will be noted that throughout the appended drawings, like features are identified by like reference numerals.

### DETAILED DESCRIPTION OF THE PREFERRED EMBODIMENTS

The present document describes a vehicle-mounted articulated arm for discharging bins in a collection container. The arm comprises an attachment section which allows for mounting the arm on the chassis of the collection container without effecting any alterations to the existing mechanism/structure of the collection container and/or the truck on which the collection container is provided. The arm also comprises an articulation mechanism which allows the arm to: extend for grabbing the bin, retract backward while grabbing the bin without completely folding, lift the bin upward to discharge its content in the collection container, lower the bin, place it back on the ground, and retracts back toward the collection container for storage and/or transportation. The weight of the bin and the weight of the arm itself may be used to fold the arm after retracting, in order to save energy and reduce the complexity of the cylinders. In an embodiment, the arm may be made from light materials such as aluminum without affecting its lifting capacity.

An arm in accordance with the present embodiments may be used in a variety of applications such as in municipality services for the collection of waste/recycle bins, in the agriculture/food sector for collection of fruits and vegetables, in the medical field for the collection of containers/recyclable medical appliances, and a variety of other fields without departing from the scope of the invention.

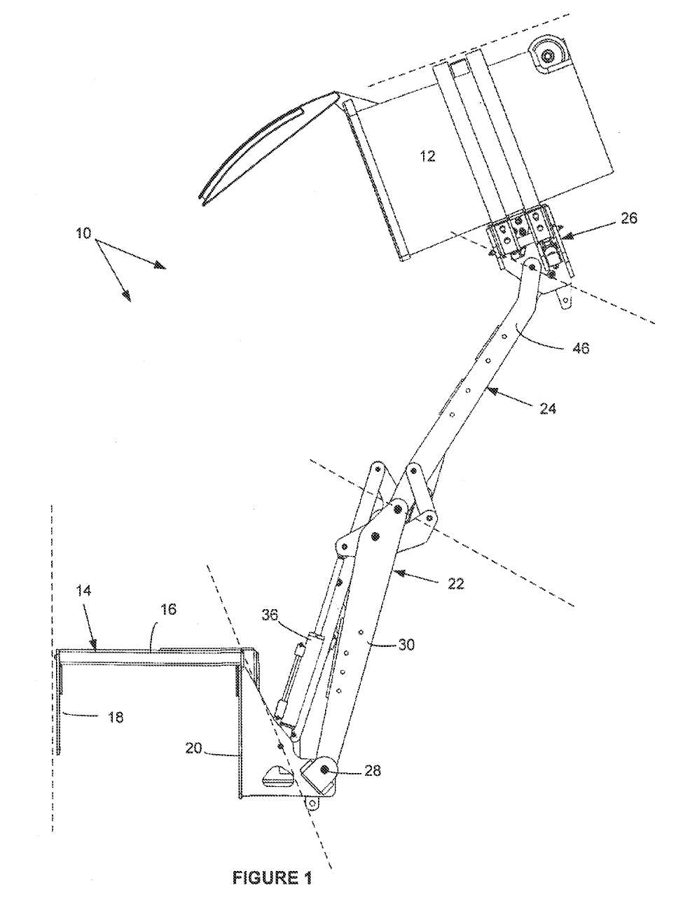

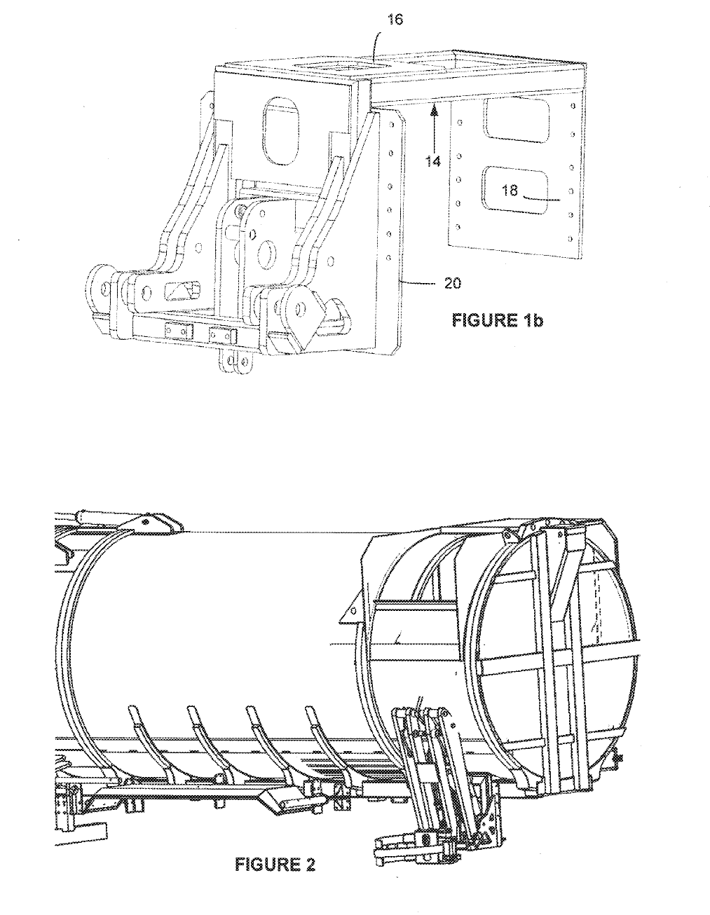

FIG. 1 is a side view of an embodiment of a vehicle-mounted articulated arm 10, in a discharging position. In an embodiment, the arm 10 includes four main sections 14, 22, 24, and 26, as defined by the dotted lines in FIG. 1. The four sections are rotatably attached to each other.

The first section is an attachment section 14 for operatively attaching the arm 10 to the chassis of the collection container, as shown in FIG. 2. An example of the collection container illustrated in FIG. 2 is described in U.S. patent application Ser. No. 12/963,586 which is incorporated by reference herein in its entirety. The attachment section 14 may have a U-shape comprising a middle portion 16, an inner portion 18, and an outer portion 20 facing the bin. In an embodiment, the outer portion 20 has a triangular shape and includes a plurality of perforations for attaching other elements of the second section as shown in FIG. 1b. The middle portion 16 may be used with different shims, and may be adapted to different chassis widths.

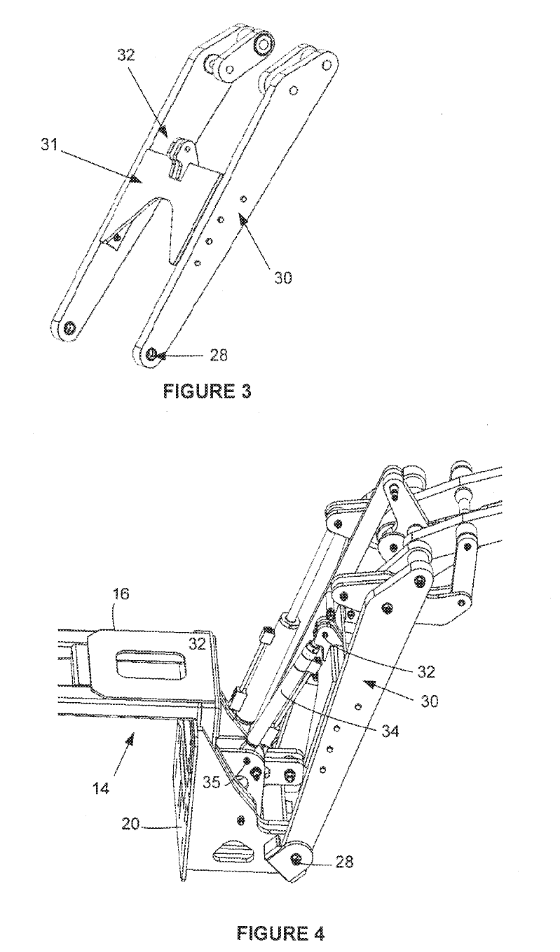

The second section 22 is rotatably attached to the attachment section 14 at pivot point 28. The second section 22 includes a chassis 30, shown in FIG. 3, having a triangular shape when viewed from the side, and a hook 32 for receiving a reach cylinder 34. The reach cylinder 34 (e.g. a hydraulic cylinder) is attached to the hook 32 on one end and to the attachment section 14 at pivot point 35, on the other end, as shown in FIG. 4. The pivot point 35 is spaced apart from the pivot point 28 so that the axial movement of the reach cylinder 34 may exert a torque on the chassis 30 and cause it to rotate around the pivot point 28. Accordingly, when the reach cylinder 34 extends due to a positive pressure applied therein, the chassis 30 rotates clockwise away from the collection container to unfold, and when the reach cylinder 34 retracts due to a negative pressure applied therein, the chassis 30 rotates counterclockwise toward the collection container to a folding position.

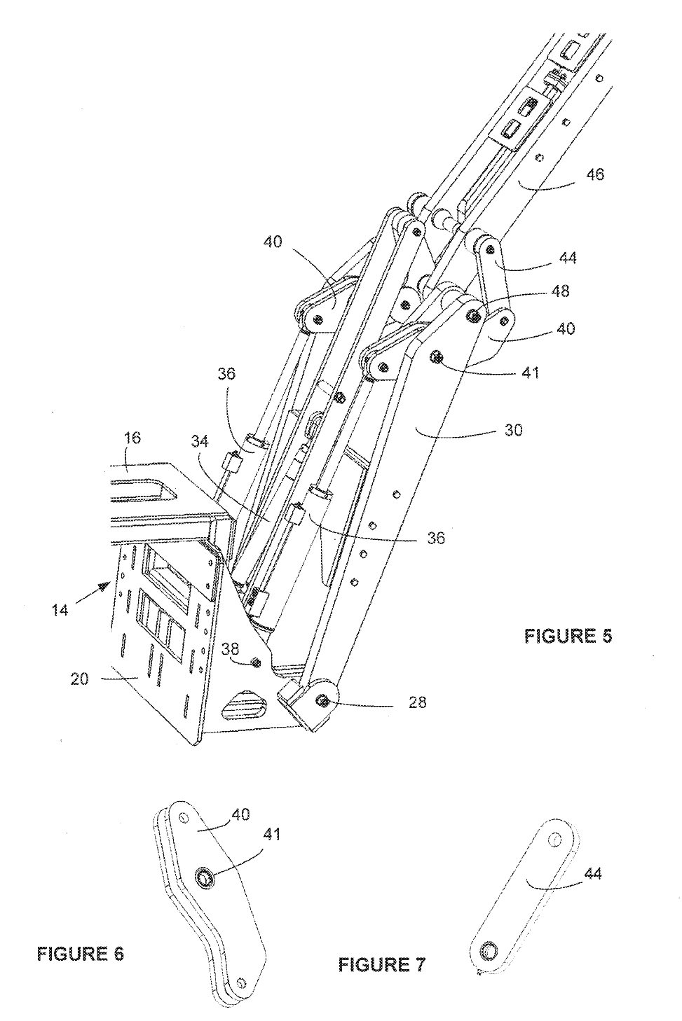

The second section 22 also includes a pair of elevation cylinders 36, as shown in FIG. 5. Each of the elevation cylinders 36 is connected on one end to the attachment section 14 at a pivot point 38, and on the other end to a rod 40, such as that shown in FIG. 6. Each rod 40 has three pivot points: a first pivot point connected to the elevation cylinder 36 at an end of the rod 40, a second pivot point toward the middle of the rod 40 for connection to the chassis 30, and a third pivot point at the opposite end of the rod 40. The third pivot point is for connection to a second rod 44, shown in FIG. 7, which is pivotally connected to a chassis 46 of the third section 24.

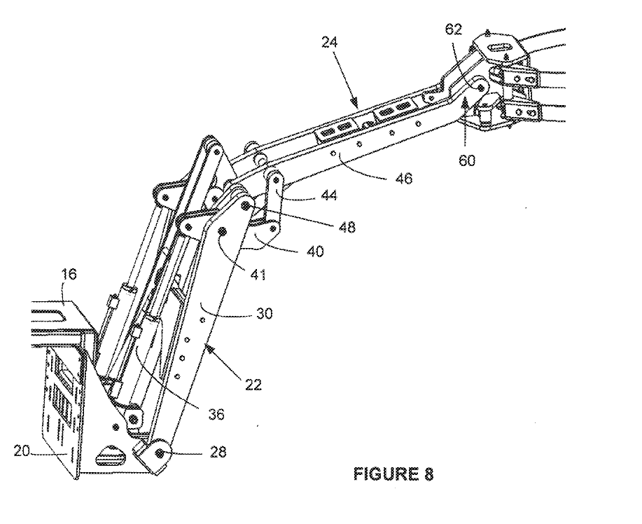

FIG. 8 is a side view of the third section 24 in an elevation position. The third section 24 includes a main chassis 46 which is rotatably attached to the chassis 30 of the second section 22 at pivot point 48. In operation, when the elevation cylinders 36 retract, the rod 40 would rotate counterclockwise, and cause the second rod 44 to exert a torque on the chassis 46 causing it to rotate around the pivot point 48 in the same direction of rotation, thus moving upward. Similarly, when the elevation cylinders 36 extend, the rod 40 would rotate clockwise around the pivot point 41 and cause the chassis 46 to rotate clockwise, thus, moving downward.

During folding and unfolding, the cylinders 36 and the rods 40 and 44 may be used to rotate the chassis 46 around the pivot point 48 simultaneously as the chassis 30 rotates around the pivot point 28, and in an opposite direction of rotation. In particular, when the third section 24 is not elevated, the elevation cylinders 36 would be extended to their maximum, thus, acting like rods when pulled further. Therefore, as the reach cylinder 34 rotates the chassis 30 clockwise around pivot point 28, the elevation cylinders 36 would exert a torque on the rod 40 which would cause the second chassis 46 to rotate counterclockwise around the pivot point 48, and vice versa.

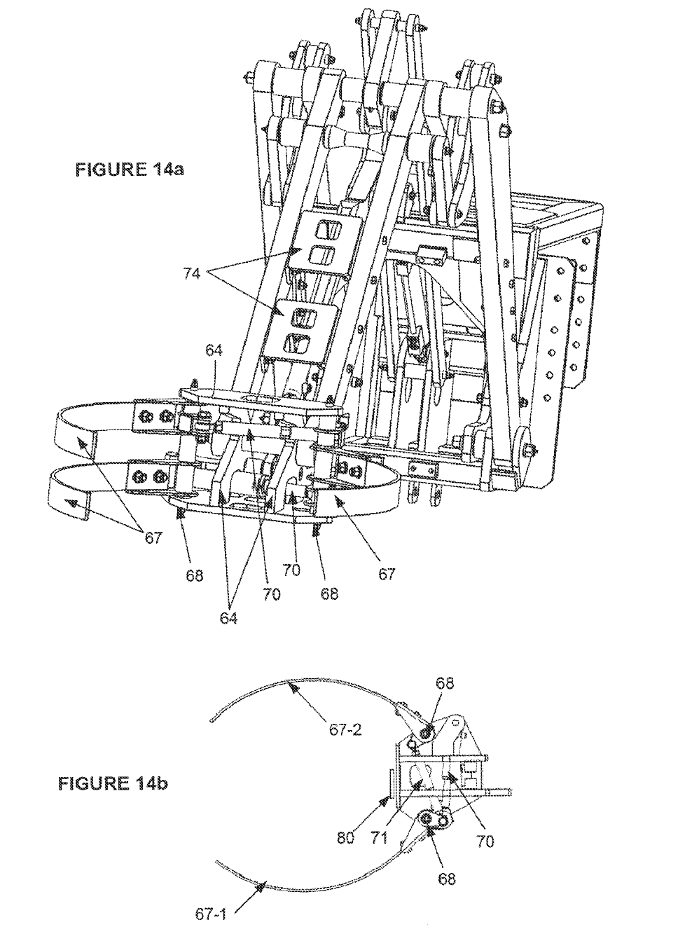

In the above embodiments, the chassis 30 and 46 may each be made from a pair of elongated members joined by one or more linking members such as linking member 74 shown in FIG. 14a, or linking member 31 shown in FIG. 3. In another embodiment, the components of the arm 10 are provided in a symmetrical position with regard to the reach cylinder 34 as shown in the Figures.

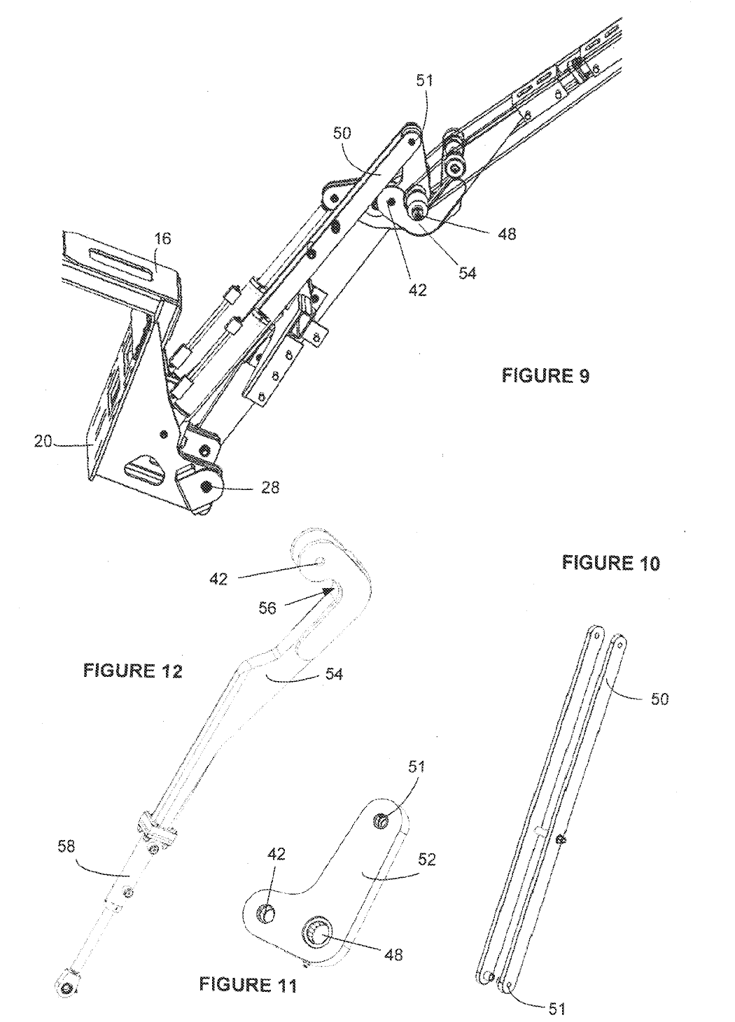

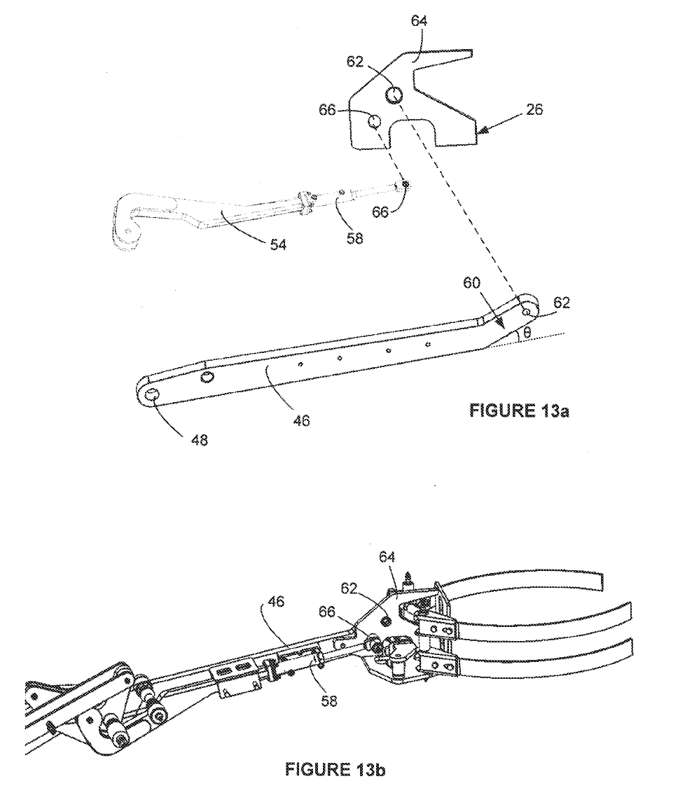

FIG. 9 illustrates a tilt control mechanism for controlling the elevation and horizontal orientation of the fourth section 26. The tilt-control mechanism comprises a tilt control arm 50, shown in FIG. 10, which is pivotally connected to the outer portion 20 of the attachment section 14 on one end, and to an L-Shaped rod 52, shown in FIG. 11, at pivot point 51 on the other end. The L-shaped rod 52 has three pivot points, one for connection to the arm 50, one for connection to the axis of rotation 48 (aka pivot point 48), and a third one for connecting to another arm 54, shown in FIG. 12, of the third section 24, at pivot point 42. The arm 54 has the shape of a question mark (or L shape) at one of it ends, and defines a circular groove 56 for receiving the rotation shaft 48 (aka pivot point 48). The arm 54 is housed within the chassis 46 with the L-shaped end extending from an end of the chassis 46 for connecting to the L-shaped rod 52 as shown in FIG. 9. Operation of the tilt control mechanism will be described hereinbelow after describing the operation of the grabbing section 26. In an embodiment, the arm 54 comprises a tilt cylinder 58 opposite to the L-shaped end. This cylinder is used to tilt the fourth section 26 as the bin 12 approaches the collection container. This embodiment is illustrated in more detail with reference to FIG. 13a.

FIG. 13a is an exploded view of the tilting mechanism used for tilting the bin 12 to discharge its content in the collection container. In the present embodiment, the chassis 46 may have an end portion 60 which defines an angle 8 with the longitudinal axis of the chassis 46. A pivot point 62 at the end of the end portion 60 connects the chassis 46 to the chassis 64 of the fourth section 26, as shown in FIG. 13b. FIG. 13b is an inside view of the tilting mechanism.

As stated above, the arm 54 is housed within the chassis 46. The moving end of the tilt cylinder 58 is connected to the chassis 64 of the fourth section 26 at a pivot point 66 which is distant from the pivot point 62. Whereby, when the cylinder 58 extends or retracts, it exerts a torque on the chassis 64 due to the distance between the pivot points 62 and 66, thus, tilting the chassis 64 to discharge the bin 12, as shown in FIG. 1.

The fourth section 26 is that which grabs the bin 12 from the ground and returns it back after discharging it. The process of tilting the chassis 64 of the fourth section has been explained above with reference to FIGS. 13a and 13b.

In addition to the chassis 64, the fourth section 26 comprises a set of clamps 67 at opposite sides of the chassis 64 for grabbing the bin 12. FIGS. 14a is a front view of the fourth section without the front protecting cover, and FIG. 14b is a top view of the fourth section without the top protecting cover. As shown in FIGS. 14a and 14b, the set of clamps comprises at least one clamp 67 at each side. Each clamp 67 is rotatably attached to the chassis 64 using a rotation shaft 68. Movement of the clamps 67 is controlled by a clamping cylinder 70 which open the clamps when extending and close them when retracting by exerting a torque thereon. As illustrated in FIG. 14b, the torque is applied to the clamps 67-1 directly by the cylinder 70. The torque is transferred to the clamps 67-2 on the opposite side using a rod 71, as shown in FIG. 14b, whereby the clamps 67-1 and 67-2 open and close simultaneously following the motion of the cylinder 70.

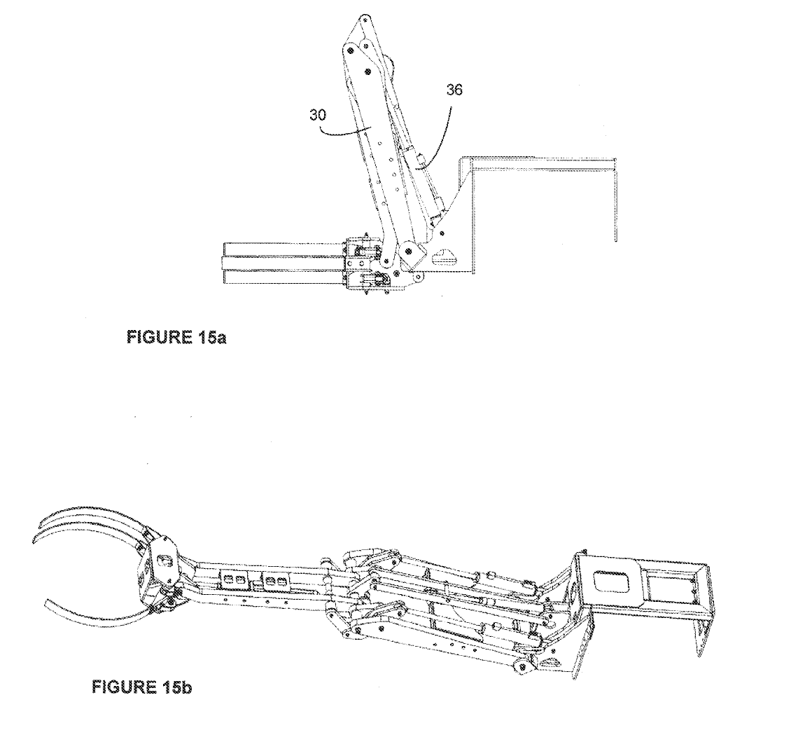

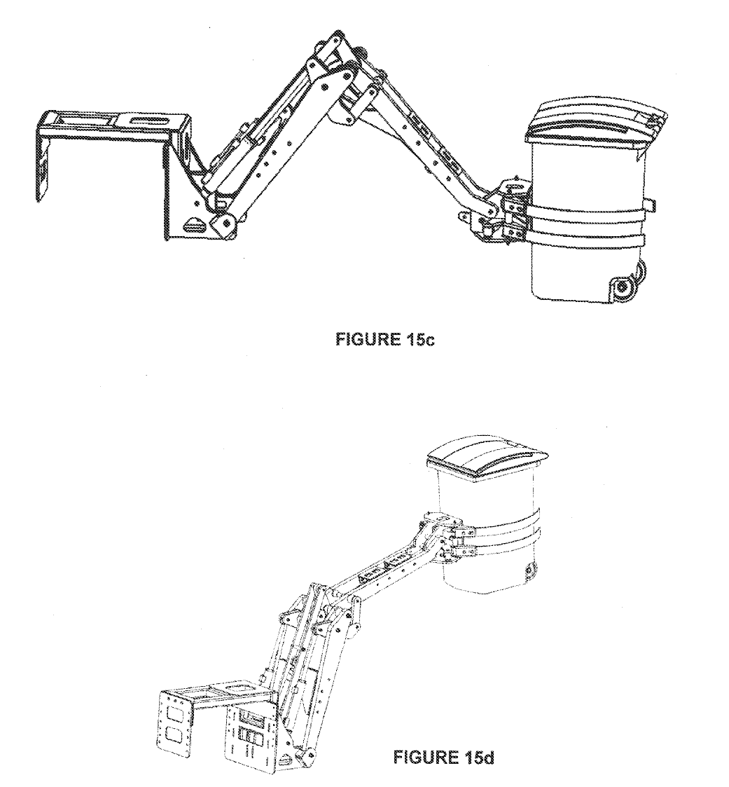

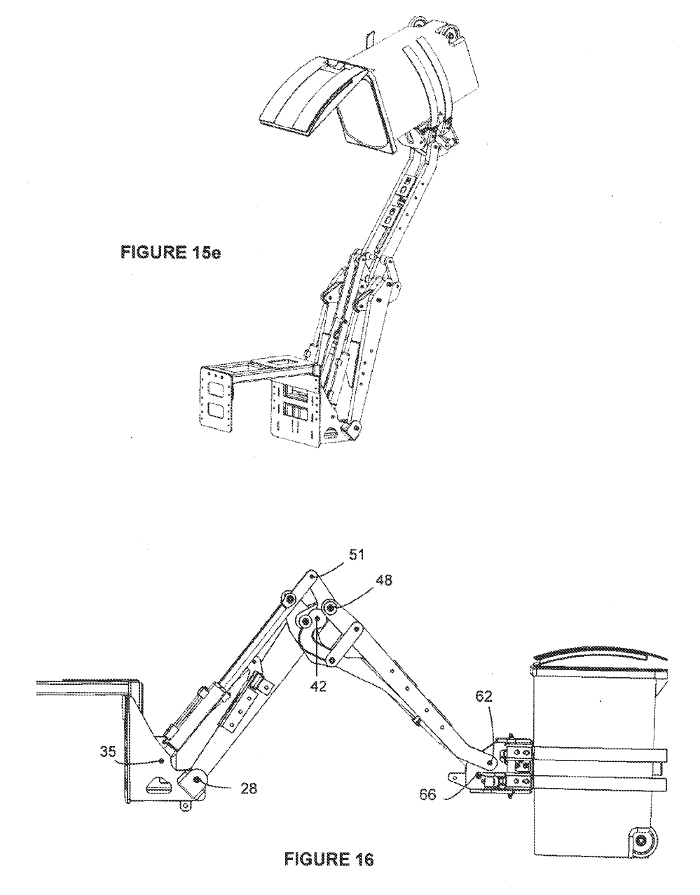

FIGS. 15a to 15e illustrate the articulated arm 10 in different stages of operation with the arm 10 ranging between a storage position (aka folding position) in FIG. 15a, to a reach position to grab a bin in FIG. 15b, to a grabbing position in FIG. 15c, to a lifting position in FIG. 15d, to a discharging position in FIG. 15e when the cylinder 58 (see FIGS. 13a and 13b) extends to tilt the chassis 64 and the bin attached to it. In an embodiment, the third section 24 may be received by the second section 22 when in storage position, as shown in FIG. 15a, in order to minimize the space taken by the articulated arm 10 during storage and transportation.

It should be noted that, due to the shape of the arm 54, rod 52, arm 50 and the position of the different pivot points of the arm, the elevation of the fourth section 26 from the ground remains substantially the same as the arm 10 moves between the folding position in FIG. 15a to the grabbing position in FIG. 15c, and vice versa. The fourth section 26 also remains in a horizontal position as the arm 10 moves between the folding position in FIG. 15a to the grabbing position in FIG. 15c to the elevation position shown in FIG. 15d, in order to avoid spilling the content of the bin.

Referring back to FIG. 9, as the chassis 30 rotates, a torque is exerted by the arm 50 onto the L-shaped rod 52 (due to the distance between pivot points 51 and 48). The torque exerted onto the rod 52 is transferred to the arm 54 due to distance between the axis of rotation 48 and the pivot point 42 which connects the rod 52 and the arm 54. The arm 54 would act on the pivot point 66 which connects the cylinder 58 with the chassis 64 (see FIG. 13a). The pivot points 35 (reach cylinder 34 and attachment section 14), 28 (attachment section 14 and chassis 30), 51 (L-shaped rod 52 and arm 50), and 48 (chassis 30, chassis 46 and middle of L-shaped rod 52) form a polygon which looks substantially like a parallelogram, as shown in FIG. 16. A second polygon which also looks substantially like a parallelogram consists of pivot points 48(chassis 30, chassis 46 and middle of L-shaped rod 52), 42 (L-shaped rod 52 and arm 54), 62 (chassis 46 and chassis 64), and 66 (chassis 64 and tilt cylinder 58), as shown in FIG. 16.

Accordingly, segment 62-66 remains substantially parallel to segment 48-42, and segment 48-51 remains substantially parallel to 35-28. At the same time, the position of segment 35-28 is fixed during movement the arm, and segments 48-42 and 48-51 are always at a fixed angle with respect to each other for being included in the same part such as for example the L-shaped rod 52. Therefore, segment 62-66 remain in a substantially fixed angle with respect to the fixed segment 35-28. Whereby, the clamps 67 remain in a substantially horizontal position during folding and unfolding and when the third section rotates upward to lift the bin toward the collection container.

In an embodiment, the clamps 67 and the bin 12 start to be inclined slightly as the arm 10 elevates the bin past the position shown in FIG. 15d, in preparation for discharging the bin. In this position, the parallelogram configuration will no longer apply due to the angles defined by the pivot points extending past 180°.

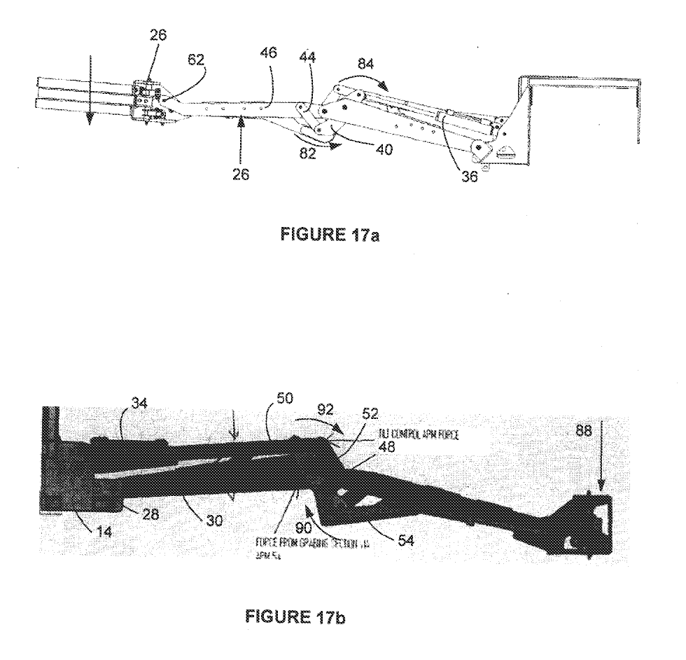

In accordance with a further embodiment, the weight of the bin may be used to reduce/eliminate the hydraulic pressure needed to retract the arm 10 toward the folding position. Since both the chassis 46 and the arm 54 are attached to the chassis 64 of the grabbing section 26 (see FIGS. 13a and 13b) the weight of the bin may be applied to the second section 22 through these two elements. FIG. 17a illustrates the concept of applying the weight of the bin for retracting the arm though the chassis of the second section, and FIG. 17b illustrates the concept of applying the weight of the bin for retracting the arm though the arm housed within the chassis of the second section.

As illustrated in FIG. 17a, the weight applied though the chassis 46 of the third section 24 exerts a torque on the rod 44. The torque is transferred to the rod 40 in the direction of arrow 82. The rod 40 would transfer the torque to the elevation cylinder 36 in the direction of arrow 84 as a negative pressure applied on the elevation cylinder 36. Such negative pressure would cause the cylinder 36 to retract, thus, folding the arm 10.

Additionally, as illustrated in FIG. 17b, the weight of the bin is applied on the grabbing section 26 in the direction of arrow 88. The weight applies a torque on the arm 54, as indicated by arrow 90, the torque is transferred to the arm 50 in the direction of arrow 92. The torque is applied through the pivot point 48 which is distant from pivot point 28 (chassis 30 and attachment section 14), thus, causing the chassis 30 to rotate counterclockwise around pivot point 28 toward a folding position.

Therefore, the heavier is the bin 12, the higher the pressure applied toward the retracting of the arm, and the lower is the pressure needed in the reach cylinder 34 to retract the arm after grabbing the bin. The design has the advantage of lowering energy consumption, and reducing the size and capacity of the reach cylinder 34 which would otherwise have to be up to five times more powerful (heavier and energy consuming) to grab the same bin.

Accordingly, embodiments of the invention describe a vehicle-mounted articulated arm 10 which is ready to use without effecting any changes to the existing structure/chassis of the collection container or the truck associated with the latter. In an embodiment, the arm 10 may weigh 850 pounds, may extend up to 8 to 16 feet, and grab a bin that may weigh up to 500 to 2000 pounds. The arm 10 does not include any adjustable parts, and thus, does not need any adjustment after lubrication. In average, the arm 10 may include approximately 70% solid pieces, and 30% in welded parts, screws, rotation shafts and other accessories. In an embodiment, a camera may be provided in order to allow the driver to position the arm with respect to the bin. The output of the camera is viewed on a display (not shown) inside the cabin of the truck. Communication between the camera and the display inside the truck may be performed using known techniques.

The arm may have different modes of operation. For instance, the arm maybe used semi-automatically or fully automatically. In an embodiment, the arm 10 may include a contact sensor 80, shown in FIG. 14b, for stopping the arm from extending further when contacting the bin 12, and for closing the clamps 67 on the bin. The contact sensor may be a mechanical sensor or an electrical one (e.g. using infrared).

While preferred embodiments have been described above and illustrated in the accompanying drawings, it will be evident to those skilled in the art that modifications may be made without departing from this disclosure. Such modifications are considered as possible variants comprised in the scope of the disclosure.

For example, while FIG. 2 shows the arm 10 as being mounted on the right side of a collection container, it should be noted that the arm 10 may also be mounted on the left side, or both sides if needed. It is also possible to use more than one arm 10 on each side of the collection container depending on the need and application. Furthermore, it is possible to mount the arm 10 on the collection container or also the chassis of the truck carrying the collection container due to the fact that the attachment section 14 may be used in a variety of different positions.

1. An articulated arm for mounting on a collection container or a chassis of a vehicle carrying a collection container for discharging bins, comprising:
an attachment section for attaching to the collection container or the chassis of the vehicle;
an elongated first section having a first end and a second end, said first end of the first section being pivotally connected to the attachment section at a first pivot point;
an elongated second section having a first end and a second end, said first end of the second section being pivotally connected to the second end of the first section at a second pivot point;
a grabbing section pivotally connected to the second end of the second section at a third pivot point, said grabbing section including a set of clamps which rotate between an open position for storage and transportation and a closed position for holding the bin;
said arm comprising an articulation mechanism which allows the arm to move from a folding position to an extended position for grabbing the bin, rotate around the second pivot point for lifting the bin toward an opening of the collection container, and tilt the grabbing section around the third pivot point for discharging the bin into the collection container.

2. The articulated arm of claim 1, wherein the grabbing section remains in a substantially parallel position to the ground as the arm is lifting the bin toward the opening of the collection container.

3. The articulated arm of anyone of claim 1, wherein the grabbing section remains in a substantially parallel position to the ground as the arm is folding and unfolding.

4. The articulated arm of anyone of claim 1, wherein grabbing section maintains its elevation from ground when unfolding to grab the bin.

5. The articulated arm of anyone of claim 1, wherein, the weight of the bin exerts a pressure which assists in retracting the arm toward the folding position.

6. The articulated arm of claim 5, wherein the pressure is proportional to the weight of the bin.

7. The articulated arm of claim 1, further comprising a reach cylinder pivotally connected between the first section and the attachment section, said reach cylinder cause the arm to unfold when extending, and to fold when retracting.

8. The articulated arm of claim 7 wherein, during folding and unfolding of the arm, the first section rotates around the first pivot in a direction of rotation that is opposite to a direction of rotation of the second section around the second pivot point.

9. The articulated arm of anyone of claim 1, further comprising at least one elevation cylinder pivotally attached to the attachment section at one end and to an elevation rod at another end, said elevation rod to exert an elevation-torque on the second section which causes the second section to rotate around the second pivot point, following an axial movement by the elevation cylinder.

10. The articulated arm of claim 9, wherein rotation of the first section around the first pivot point causes the elevation cylinder to exert a torque on the elevation rod to rotate the second section around the second pivot point in a direction of rotation that is opposite to the direction of the first section around the first pivot point.

11. The articulated arm of anyone of claim 1, wherein the second section comprises a tilt cylinder operatively connected to the grabbing section for tilting the grabbing section around the third pivot point when the bin approaches the opening of the collection container.

12. The articulated arm of anyone of claim 1, wherein the clamps are connected to a grabbing cylinder for opening and closing.

13. The articulated arm of anyone of claim 1, wherein the second section is received within the first section when in a folding position.

14. The articulated arm of anyone of claim 1, wherein the arm is made from a material lighter than steel.

15. The articulated arm of anyone of claim 1, wherein the arm is made substantially entirely from aluminum.

16. The articulated arm of anyone of claim 1, wherein the arm weights 850 pounds, extends up to 16 feet and grabs a bin that weighs up to 2000 pounds.

17. An articulated arm for mounting on a collection container or a chassis of a vehicle carrying a collection container for discharging bins, comprising:
an attachment section for attaching to the collection container or the chassis of the vehicle;
an elongated first section having a first end and a second end, said first end of the first section being pivotally connected to the attachment section at a first pivot point;
an elongated second section having a first end and a second end, said first end of the second section being pivotally connected to the second end of the first section at a second pivot point;
a grabbing section pivotally connected to the second end of the second section at a third pivot point, said grabbing section including a set of clamps which rotate between an open position for storage and transportation and a closed position for holding the bin;
said arm comprising an articulation mechanism which allows the arm to move from a folding position to an extended position for grabbing and discharging the bin, wherein the weight of the bin exerts a pressure which assists in retracting the arm toward the folding position.
